(19) United States
(12) Patent Application Publication
(10) Pub. No.: US 2012/0226743 A1
(43) Pub. Date: Sep. 6, 2012

(54) SYSTEMS AND METHODS FOR CUSTOMIZED MULTIMEDIA SURVEYS IN A SOCIAL NETWORK ENVIRONMENT

(75) Inventor: Aaron Smargon, New York, NY (US)

(73) Assignee: VERVISE, LLC, New York, NY (US)

(21) Appl. No.: 13/411,418

(22) Filed: Mar. 2, 2012

Related U.S. Application Data
(60) Provisional application No. 61/449,257, filed on Mar. 4, 2011.
(60) Provisional application No. 61/498,373, filed on Jun. 17, 2011.

(51) Int. Cl. G06F 15/16

(52) U.S. Cl. 709/203

(57) ABSTRACT

Customized multimedia surveys are provided in a social network environment. A user that initiates the survey provides survey content and properties. The properties include criteria specifying which users are eligible to participate in the survey. Users eligible to participate can be identified by querying a database of user properties. The survey can include text, images, audio, video, and other media. Eligible users are invited and responses are received from those who agree to participate. Survey results are compiled from the responses received. Rewards may be provided to respondents. The reward may be provided in an ecommerce system that includes both redeemable and non-redeemable points. Cash can be converted to non-redeemable points. Redeemable can be converted to cash. A transaction may transfer redeemable points from a first user to a second user with points converted from non-redeemable points to redeemable points in limited circumstances.

### CROSS-REFERENCE TO RELATED APPLICATIONS

This application claims the benefit of U.S. provisional application No. 61/449,257, filed Mar. 4, 2011, and U.S. provisional application No. 61/498,373, filed Jun. 17, 2011, all of which are hereby incorporated by reference.

### BACKGROUND

The present invention relates to social network applications and to systems and methods for customized multimedia surveys in a social network environment.

A social network service provides an online platform that allows users to build a network of relationships with other users who share common interests. The popularity of social network services has grown exponentially in recent years. Most social network services provide users with the ability to create a personal profile and to upload or generate content that can be shared with other users, such as photos or blog entries.

As social network services continue to evolve, individuals continue to use these services for sharing information with other users, and businesses have begun to use these services to disseminate information about their products and services. Improvements to social network services that allow users to share information with other users in new and interesting ways will be required to help differentiate social network services and to attract users.

With the advent of the Internet, ecommerce has emerged as a massive market in which businesses and consumers engage in the exchange of goods and services for cash. Website companies like eBay.com and Amazon.com have provided ecommerce services through which users may participate in such transactions. While not inconvenient, such websites can sometimes suffer from tediousness, especially with respect to high volume transactions and micro transactions, for example, online transactions with cash values below $10.

Some services provide some form of virtual currency. Facebook.com, for example, has an online currency called “Facebook Credits” which can be purchased with real currency on a fixed currency-credits exchange rate. These credits, however, are limited on at least two accounts. First, they are not redeemable for cash. Second, they can only be used to purchase virtual goods and services from Facebook.com and affiliated companies.

### SUMMARY

Systems and methods for customized multimedia surveys in a social network environment are provided. In one aspect, the invention provides a computer-implemented method for conducting a multimedia survey of users of a social network. The method includes: receiving survey attributes from a first one of the users; identifying users eligible for the survey based on the survey attributes; selecting potential respondents from the users identified as eligible; inviting the selected potential respondents to respond to the survey; and collecting responses from the invited potential respondents.

In another aspect, the invention provides a computer-implemented method for conducting a multimedia survey of users of a social network. The method includes: receiving survey content and respondent eligibility criteria from a first one of the users; announcing the survey to the users; receiving requests to participate in the survey from some of the users; allocating invitations to participate in the survey to a selected set of the users from which requests to participate in the survey where received; and collecting survey responses from the selected set of the users.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is an illustration of aspects of a system for customized multimedia surveys in a social network environment in accordance with aspects of the invention;

FIG. 2 is block diagram of a survey server in accordance with aspects of the invention;

FIG. 3 is a flow diagram of aspects of an ecommerce system in accordance with aspects of the invention;

FIG. 4 is a flowchart of a process for creating a survey and processing survey results in accordance with aspects of the invention;

FIG. 5 is a flowchart of a process for collecting survey responses in accordance with aspects of the invention;

FIG. 6 is a flowchart of another process for creating a survey and processing survey results in accordance with aspects of the invention;

FIG. 7 is a flowchart of a process for processing survey participation requests in accordance with aspects of the invention; and

FIG. 8 is a flowchart of another process for collecting survey responses in accordance with aspects of the invention.

### DETAILED DESCRIPTION

Systems and methods are provided for conducting surveys in a social network environment. The techniques disclosed herein provide a user of a social networking site with the ability to generate a multimedia survey that can be conducted with users of the social networking site. The multimedia survey can include one or more questions, a survey, a task, a forum thread, and any other content that requests a response or action from users of the social networking site. The user initiating the survey can provide multimedia content, including text, images, audio, video, interactive content, or other documents, to be presented to respondents of the survey. The user initiating the survey can also define criteria for selecting potential respondents for the survey. The survey can be public, where any user meeting the criteria for the survey can choose to respond, or private, where only selected users receive an invitation to participate in the survey.

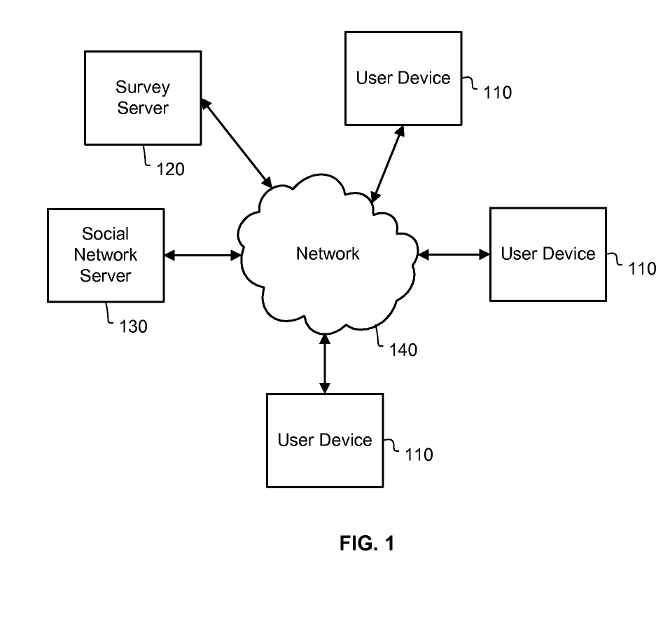

FIG. 1 is an illustration of aspects of a system for customized multimedia surveys in a social network environment. The system includes a survey server 120, a social network server 130, and a plurality of user devices 110 that intercommunicate through a network 140.

The user devices 110 are devices through which users interact with the system. Each user device may include a processor, network interface circuitry, and memory. The user devices 110 can be various types of computing systems, such as laptop computers, handheld computers, tablet computers, mobile phones, and other devices capable of accessing and displaying web pages from the Internet. The user devices 110 may have a wired or wireless connection to the network 140. The user devices 110 can include browser software that enables to a user of the devices to access web pages of the social network server 130 and the survey server 120. Although users of the survey system are often individuals, a user may also be another system, or a group of individuals, for example, employees of a business.

The network 140 may be a public network or set of interconnected networks, such as the Internet. In an embodiment, the user devices 110 can be connected to the network 140 via one or more intermediate networks, such as a local area network (LAN), a wide area network (WAN), a personal area network (PAN), or a wireless network.

The social network server 130 is a network-connected server computer system or set of computer systems that provides a social network service. The social network server 130 may provide various types of social network services common to conventional social networks. For example, the social network service provided by the social network server 130 may allow users of the service to create personal profiles, to link to other users, or to share multimedia content such as photos, audio, and video content. The social network server 130 may also provide privacy controls that allow a user to control the level of access that other users have to the information that the user has associated with his or her profile. For example, a user might limit access to photos that the user has uploaded to users to whom the user has linked to as a “contact.” The term “contact” refers to another user with whom the user has an established link or association in the social network. There may be different tiers of contacts, such as family, friends, colleagues, and acquaintances. Each tier of contacts can be assigned a customized level of privacy. For example, a user of the social network service might configure the privacy setting on his or her profile such that a family member can access certain content that the user has posted but acquaintances and colleagues cannot access this content. In some social networks, a first user can send a request to a second user to add them as a contact, and if the second user accepts the first user's invitation, a link between the profile of the first user and the second user is established. In some social network services, linking to another user as a contact can provide various benefits to the users, such as access to content that is only available to other users who are linked to one another and the ability to send private messages to one another.

The survey server 120 is a network-connected server computer system or set of computer systems that provides customized multimedia survey services. The survey services are used with the social networking services provided by the social network server 130. Although FIG. 1. illustrates the survey server 120 and the social network server 130 as separate computer systems, in alternate systems, one network-connected server computer system or set of computer systems provides both the social network service and the customized multimedia survey services. In other embodiments, the survey server 120 may provide customized multimedia survey services to multiple social network services.

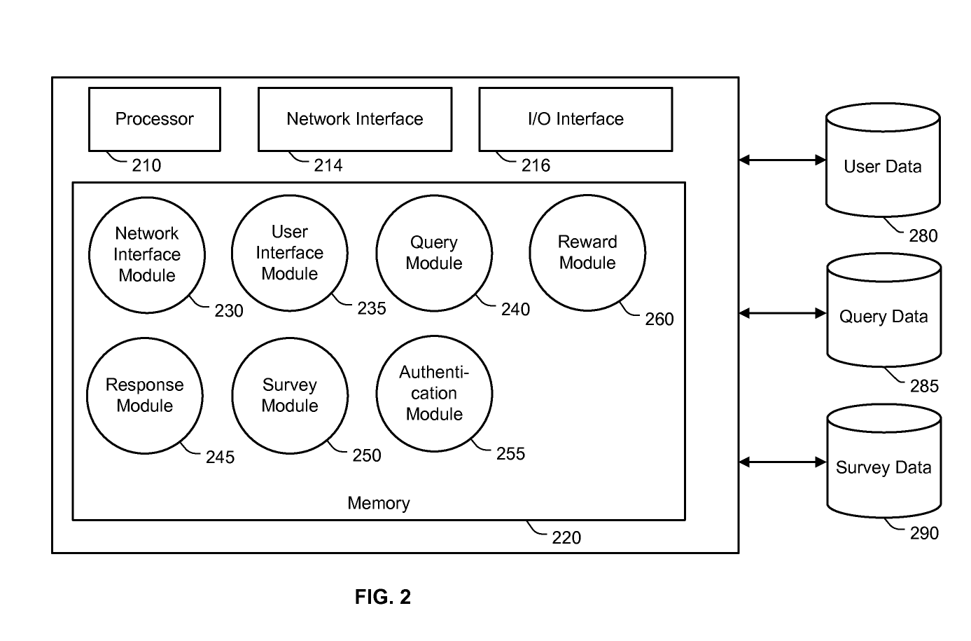

FIG. 2 is block diagram of a survey server. The survey server may be used to implement the survey server 120 of the system illustrated in FIG. 1. The survey server 120 includes a processor 210 for executing computer-software instructions, and a memory 220 that can be used to store executable software program modules that can be executed by the processor 210 of the survey server 120. The survey server 120 also includes a network interface 214 and an input-output (I/O) interface 216.

The memory 220 includes a non-transitory computer readable medium used to store program instructions executable by the processor 210. The memory 220, as illustrated in FIG. 2, stores a set of executable program modules including a network interface module 230, a user interface module 235, a query module 240, a response module 245, a survey module 250, an authentication module 255, and a reward module 260. In an alternative embodiment, one or more of these modules can be implemented in hardware, software, or a combination thereof. The memory 220 also includes non-persistent memory, such as random access memory (RAM), for use by the processor 210. The survey server 120 can include multiple processors 210.

The I/O interface 216 can be connected to various input/output devices that allow interaction with the survey server 120. For example, the I/O interface 216 may receive input from a keyboard, a mouse, a trackball, a microphone or other types of input devices. For another example, the I/O interface 216 may supply audio and video signals to speakers and display devices.

The survey server 120 uses a user data store 280, a query data store 285, and a survey data store 290. The data stores may be implemented using various database technologies that allow data to be organized, stored, and retrieved from the data stores. The data stores may be implemented on the same server or set of servers as the survey server 120, remotely on a separate server or servers coupled to the survey server 120, or some combination. Remote data stores can be coupled to the survey server 120 via one or more networks, such as the network 140, a local area network (LAN), a wide area network (WAN), other types of network, or a combination thereof. Additionally, the data stores illustrated in FIG. 2 may be combined or further divided.

The network interface module 230 provides network connectivity to and from the survey server 120 via the network interface 214. The network interface module 230 can format data to be transmitted to the user device 110, to the social network server 130, or to other network-connected devices. The network interface module 230 can also convert data received from the network 140 via the network interface 214 into a format used by one of the other modules and or subsystems of the survey server 120.

The user interface module 235 provides user interfaces, such as a web page or set of web pages, for users to interact with the customized multimedia survey services provided by the survey server 120. For example, the user interface module 235 can provide an interface for creating a new survey, an interface for creating a query to select potential respondents to the survey, an interface for presenting survey content to respondents to surveys, and an interface for presenting survey results.

The authentication module 255 can control access to the survey system including user profile information and survey content and results. The authentication module 255 requires users to provide credentials to verify their identities. For example, the authentication module 255 may require users to enter a username and password or username and personal identification number (PIN). The authentication module 255 may also use biometric information, such as fingerprint information, facial recognition, palm print recognition, or iris or retina recognition, to verify the identity of the user based the user's physiological attributes. The authentication module 255 may encrypt communications from the survey server 120 and decrypt communications to the survey server 120 so that unauthorized third parties cannot easily intercept or access user profile information or survey content or results being transmitted across the network 140. Encryption keys associated with specific users can be used to ensure that those attempting to access the system are who they are purported to be. The user interface module 235 may generate a login screen or web page that allows users to provide login credentials. In embodiments where the survey server 120 is implemented as part of a social network service on the social network server 130, the authentication module 255 can use the same authentication information used by the social network server 130 for controlling access the social network content.

The survey module 250 allows users to create new surveys, monitor the progress of ongoing surveys, and view survey results. The survey module 250 compiles the results of survey responses received from respondents to the survey. The survey module 250 also publishes the results of the survey. The user interface module 235 can provide a survey interface, such as a web page or series of web pages, that allows a user to interact with the survey module 250. The survey interface can include a survey creation interface that includes a screen or series of screens that walk a user through the steps of creating a new survey.

The survey creation interface allows the user initiating the survey to define various attributes of the survey including the properties and content, including layout of the survey. The survey properties can include a picture or other multimedia content, tags of related concepts, the type of survey, a summary of the survey, survey visibility, expiration date and time, respondent selection criteria (for example, who and how many), and respondent data requests. The respondent selection criteria and respondent data requests can be implemented by the query module 240 as described below. The survey attributes may additionally include possible rewards, for example, in cash, points or other currency, or various prizes, and how the rewards are to be distributed. For example, when the user wants to offer rewards of points or cash, the survey creation interface can accept payments (e.g., from a debit or credit card) to fund cash rewards and can accept points from a points system to fund point rewards. The survey content can include survey prompts that are displayed to a user requesting that the user provide a response or perform some task. The survey content can also include requested survey response formats that can be displayed in response to these prompts indicating a specific type of response to each survey prompt or requested task. The survey content may include one or more media types, such as image content, text content, audio content, video content, uploaded documents, interactive content, or a combination thereof. The content can also have various levels of interactivity. For example, the survey content can include one or more interactive elements, such as a game, that can be used to draw potential respondents to participate in the survey. This content can include one or more survey questions to be presented to a user. The questions can be presented in text, image, audio, video, or uploaded document format. The survey creation interface may allow a user to select content stored on the user device 110 or other network location and upload the content to the survey server 120. The survey module 250 can store this content in the survey data store 290. The survey module 250 can also store layout information and other information related to the survey, such as the start and end times for the survey and visibility of identities of the various users initiating the surveys and responding to the surveys. According to some embodiments, the user initiating the survey can implement a survey that does not include any respondent criteria, which would allow any member of the social network service to participate in the survey.

The survey creation interface may provide a set of layout templates from which the user initiating the survey can select. The set of layout templates can include templates for creating various types of content, such as questionnaires, to be presented to survey respondents. The user can select a template and the survey creation interface can prompt the user to select content to fill in the template based on the type of template selected. The survey creation interface may also allow the user to type in questions and other textual content to be displayed to survey respondents.

The user initiating the survey may define visibility of the survey content, survey responses, and the survey results. For example, the user initiating the survey can configure the survey visibility so that the various aspects of the survey are publicly available to all users of the social network, only available to those eligible to respond to the survey, only available to those who respond, or only available to the user initiating the survey. The user initiating the survey may also elect that the survey results be made publicly available, such as on a webpage on the Internet, or that the survey results be made available to users of the social network on a profile page or as part of other content associated with the user initiating the survey.

The user initiating the survey may define one or more rewards that can be awarded to respondents of the survey, including cash, points, and other prizes. The user initiating the survey can also decide which respondents are eligible to receive a reward. The user initiating the survey may elect that all respondents receive a reward, selected respondents receive a reward, or one or more respondents who are randomly selected receive a reward. For example, the user initiating the survey can elect to award survey respondents with points that can be used to purchase online content that a respondent can add to his or her personal webpage, use in games associated with the social network, or withdraw from the site for cash. In some embodiments, the user initiating the survey can elect to award a small cash prize to users who respond to the survey or offer a discount or rebate on products or services provided by a business associated with the user initiating the survey. In another embodiment, the reward for responding to the survey can be an entry into a drawing or lottery for a prize where a random winner is selected from a pool of eligible respondents. In some embodiments, the user initiating the survey can select one or more respondents to receive a reward. For example, the user initiating the survey might judge entries provided by respondents and select one or more respondents to receive awards based on the responses received. Rewards may also be automatically awarded based on the responses received, for example, by judging the thoroughness of the responses.

The survey server can also send various notifications to survey respondents. For example, respondents may be notified when they earn a reward for responding to a survey, when an unredeemed coupon they have earned is about to expire (for example, some number of days in advance), and when new surveys for which they qualify become available. The notifications can be sent on an as-available basis or at certain time intervals.

The survey server can also send various notifications to the user initiating the survey. For example, users initiating surveys may be notified upon completion of a survey they have issued, either because of time expiration or respondent quota has been filled, upon imminent completion of their survey (for example, when a certain number or percent of their respondent quota has responded to an active survey, when a certain amount of time has passed since the survey was issued, or when a survey is about to expire), when a draft has not been submitted after a certain time duration, or when less than a certain percent of respondents have responded within a given time period.

In some embodiments, transactional fees may be associated with the creation of a survey. In other embodiments, fees may be associated with responding to a survey. For example, the user initiating the survey may need to pay a fee in order to initiate the survey. In various embodiments, the transaction fee may be paid in cash or in points that can be earned and used on the social network service. In some embodiments, respondents to the survey are subject to a transactional fee for responding to surveys. For example, a deduction may be made from the respondent's reward. In some embodiments, the user initiating the survey can opt to pay a flat transaction fee that would allow the user initiating a survey to bear the cost of the survey rather than imposing a transactional fee based on the respondents to the survey. Yet another alternative is for the user initiating the survey to pay a fee dependent on the number of respondents, the rewards, or a combination thereof. In some embodiments, the social network service can collect the transactional fees as an additional revenue source. In other embodiments, the survey service can collect the transactional fees as a source of funding for operational costs of the survey service.

The user initiating the survey can also define a query via the user interface module 235 to identify potential respondents to the survey. The query can be defined before, during, or after the survey properties and content are established. Alternatively, the user initiating the survey can use the user interface module 235 to invite via email those who are not yet a part of the social network both to participate in the survey and to join the social network. According to an embodiment, the query module 240 or network interface module 230 can generate email messages to be sent to the potential respondents. According to some embodiments, the user initiating the survey can elect to create a public survey where any user of the social network can participate in the survey. According to an embodiment, the user initiating the survey can create a public survey by generating a query that includes anonymous users and includes no other respondent selection criteria. However, this query could potentially return an enormous number of users. Therefore, in most instances the user initiating the survey would typically include at least one respondent selection criterion.

The user initiating the survey can, in some embodiments, enter email addresses (or other identifiers) of those to be invited. This information may be entered through the user interface module 235. Additionally, the survey server 120 may store email addresses and the user initiating the survey can designate to which stored email addresses the survey should be sent. In some embodiments, surveys can be sent to a combination of users who meet the respondent selection criteria and to individuals at the email addresses specified.

The survey attributes also include whether and how identities of the participants are available. The user initiating the survey can configure the visibility of the identities of the survey initiator as well as those of the survey respondents. For example, the user can configure the survey to be published anonymously so that potential respondents are not provided the identity of the user initiating the survey. In another example, the user initiating the survey can choose to disclose his or her identity to those users participating in the survey but elect to not have the identities of the users participating in the survey disclosed.

According to some embodiments, the user initiating the survey can require that the identities of those responding to the survey be disclosed to the user initiating the survey. In other embodiments, the user initiating the survey can elect that the respondent identities not be disclosed to the user initiating the survey. In some embodiments, the respondent identities can be optionally disclosed to the initiator of the survey based on the privacy settings associated with the user profiles of the respondents. Various combinations of the identity visibility setting can be selected based on how the survey initiator wishes to configure the survey. According to an embodiment, the respondents' identities can be optionally disclosed to the initiator of the survey on a case-by-case basis by the respondents. For example, the survey content presented to a user may include an option that allows that respondent to respond anonymously or to disclose his or her identity to the user initiating the survey. In an embodiment, depending on the visibility settings as specified by the initiator, the respondent can elect to share with contacts the results of the survey with the respondent's identity revealed. In some embodiments, the survey content interface can collect identifying information from the respondents, such as a user identifier used to identify the respondent on the social network, an email address, or other contact information from the respondent, and/or the respondent's name.

According to an embodiment, the survey module 250 may send follow up messages to survey respondents after the respondents have answered a survey. A follow up message to a respondent can include additional content that the respondent may find interesting based on the respondent's responses to the survey, content related to the survey content, additional survey content, and/or invitations to participate in other surveys. The follow up message may include advertisements for products or services that the survey provider had identified as being possibly of interest to the respondent based on the respondent's responses and/or profile information on the social network service. The advertisements can be selected by the social network server 130. The follow up message may include a message from the user that initiated the survey thanking the respondent for participating in the survey and/or following up on the response. The follow up message may be sent to the user by the social network server 130.

According to some embodiments, a survey can also be accessible through a hyperlink or other navigational tool that is included in an email message or posted on a web page that is available outside of the social network. Activating the hyperlink or other navigational tool can cause the link to display the survey content within the social network, or, in some embodiments, send an invitation to the private inbox on the social network of the user who activated the hyperlink or other navigational tool.

According to some embodiments, surveys can be conducted in real-time. For example, a user could initiate a survey that is posted to a real-time discussion forum on the social network to solicit responses and the responses to the survey can be collected, processed, and displayed to users of the forum as the results are tabulated (i.e., while some users may still be responding to the survey).

The query module 240 is used to select users of the social network to participate in the survey. The query module 240 allows the user initiating the survey to generate a query to potential respondents to the survey based on selection criteria provided by the user. Multiple queries may be used for one survey. For example, the user may want to survey two groups of respondents (e.g., males and females) using the same survey. For such a survey, a specific count of responses for each group may also be requested.

Many different criteria or combinations of criteria may be used for the query. The query criteria can be combined with AND, OR, and other logical operators. Example criteria include selection based on demographic information, such as the age or age range, sex, gender, or location. The location may be determined by GPS, IP addresses, or other methods. Other example criteria include membership in various online groups, purchase histories, or indications that a potential respondent likes a certain product or service. For example, if the user initiating the survey is a home remodeling contractor, the user could require that potential respondents to the survey be homeowners within a particular set of zip codes in which the contractor works. Another type of selection criteria can be that the potential respondents are “contacts” of the user initiating the survey. Other examples of respondent selection criteria include user-entered information provided by potential respondents, such as contact information, employment information, and educational background, and network-inferred information, such as user browsing history, user links, and information derived from the user's contacts and from online communities in which the user participates. For example, the user initiating the survey may wish to limit responses to college students from a specific geographic region. For another example, the user initiating the survey may be a business and the survey may be directed to users with experiences with products or services provided by the business.

The query module 240 may also take into account the identity visibility preferences selected by the user initiating the survey. If the user initiating the survey has elected to create a survey in which the identity of the respondents is to be known to either the user initiating the survey and/or to other respondents, the query module 240 will only identify potential respondents whose privacy settings in their user profiles on the social network allow for their identities to be shared at the level of visibility required by the user initiating the survey.

The user interface module 235 provides a query interface, such as a web page or series of web pages, which allows a user to interact with the query module 240 to create and execute queries. The query interface may display a list of available respondent selection criteria to a user creating a survey and the user can select one or more selection criteria. The query interface may include a graphically interactive network of query data that allows the user to select the respondent selection criteria to be used to select potential respondents. The respondent selection criteria chosen by the user initiating the survey can then be written to the query data store 285.

In some embodiments, the initiator can select a set of user data requests of respondents that, while not used by the query to select respondents, is collected from the respondents. The user data requests provide attributes of the respondents, such as age, sex, race, occupation, etc. The requested data may be collected via the query module 240 and stored as content either in the query data store 285, the survey data store 290, or partly in both data stores. This additional data is part of the survey results. In some embodiments where any such user data is collected, the potential respondent can be notified of the data requested to be collected in an invitation as described below to allow the potential respondent to decide beforehand whether or not to respond to the survey.

The query module 240 can generate invitations to participate in a survey to a selected set of potential respondents from a pool of potential respondents identified by the query. The query module 240 may generate and send the invitations to the private inboxes of the selected set of potential respondents. Invitations as described by the various embodiments herein can include in them initiator-entered survey properties, content, and, in some embodiments, previous responses.

The survey server can limit how often users can change information on their profiles. The limit can be a time duration or a number of times that the user accesses the network between profile changes. The limit applies to editing previously entered user data. The limit, in some embodiments, does not apply to adding user data that had not previously been entered.

The response module 245 processes responses to the survey from respondents. A respondent viewing survey content from a user device 110 can submit a response to the survey. The response is forwarded over the network 140 to the survey server 120. According to an embodiment, the response data is received at the network interface module 230 via the network interface 214, and the network interface module 230 identifies the response data as a response to a survey and provides the response data to the response module 245 for processing. The response data received by the response module 245 can be stored in the survey data store 290.

According to some embodiments, the user who initiated the survey can hold the response provided by the respondent for review. The response module 245 may alert the user who initiated the survey that one or more responses to the survey are awaiting review. The user who initiated the survey can review the responses and, if the initiator of the survey objects to a response, the initiator of the survey can flag the response for review by a moderator, and the moderator can make a final disposition on the response. For example, the user who initiated the response can object to the response's utility, appropriateness, or respondent's false user data claims, and/or for other reasons. The moderator may cancel or delete a response, send a respond back to a respondent for additional information, or override the objection to the response and cause the response to be entered into the system. In some embodiments, these flagged responses may not be deleted. In some embodiments, the respondent may be given the opportunity to flag the initiator's unjustified flagging, in which case both flags must be applied in order for the moderator to consider the flagged response. In some embodiments, flagging either unchallenged or verified by a moderator may nullify the reward(s) offered to the respondent by the initiator. According to an embodiment, the user who initiated the survey can also rank the responses received. In some embodiments, the ranking can be used to determine an award to be provided to respondents of the survey, where the respondents are awarded prizes based on the rank of their responses. According to an embodiment, the initiator of the survey must process the pending responses within a certain period of time. Otherwise, the response module 245 will process the response and award any appropriate rewards to respondents to the survey.

According to some embodiments, response module 245 may allow respondents to rank a survey and/or other respondents' responses, or to flag a survey and/or other respondents' responses to request intervention by a moderator. The moderator can remove flagged surveys. According to some embodiments, other users who have visibility of survey content and survey responses can rank the survey and/or responses as well as flag the survey and/or responses for moderator attention for various reasons, such as utility, appropriateness, or false user data claims.

In some embodiments, the initiator of a multimedia survey as described by the various embodiments herein can, via the user interface module 235, save on the web pages associated with that user's profile an incomplete or complete survey which has not yet been submitted. The initiator can then return to those web pages at a later date to edit, complete, and/or submit the survey.

In some embodiments, the initiator of a multimedia survey as described by the various embodiments herein can via the user interface module 235 edit a survey even after that survey has been submitted. In such embodiments, the initiator can edit the respondent criteria, respondent number threshold, survey expiration date and/or time, reward, as well as any other such properties related to the respondents and rewards. In some embodiments, the initiator can even edit survey properties and content. In all such embodiments in which the elements of a survey may be modified, the effects of such modifications take effect immediately after the initiator has submitted the modifications via the query module 240 or the survey module 250. Any requests already submitted but which have not yet been responded to are altered to reflect the modifications. The survey results of such embodiments in which surveys are edited may incur complexities undesired by the initiator and/or potential respondents.

In some embodiments, the initiator of a multimedia survey as described by the various embodiments herein can, via the user interface module 235, open a survey that has been closed, either by increasing the respondent number threshold, setting a later expiration date and/or time, or a combination thereof.

The reward module 260 is used to provide rewards to survey respondents. Using the reward module, the user initiating the survey is able to define what reward he or she wishes to issue to respondents who qualify to receive rewards. The reward module 260 can then transfer or cause the transfer of rewards from the user initiating the survey to qualifying respondents. The rewards may be cash and points. The rewards may alternatively or additionally be coupons.

The user initiating the survey may be able to create multiple rewards for the same survey from which a respondent who earns a reward may choose. Alternatively, the user initiating the survey or the survey server 120 itself can later choose which of these rewards one or more qualifying respondents can receive. Each reward could be a coupon, cash, or points. The user initiating the survey may additionally have the option of capping the maximum number of each type of reward offered (for example, 50 of one type of coupon, 50 of another type of coupon; alternatively, one of 1,000 points and ten of 100 points). The sum of the maximums must add up to the total of allotted rewards. The survey server may or may not enforce a cap on the total number of different types of rewards that the user initiating the survey may be allowed to offer (for example, only three different types of rewards allowed).

If a respondent does not want the reward offered but still wants to respond to the survey, he or she may opt to redeem a universal or default reward distinct from the offered reward. The default reward could be a coupon, cash, or points. The universal reward is only available if the user initiating the survey indicated that the universal reward is permitted.

If a respondent does not like the offered reward by the user initiating the survey, he or she may ask for a higher reward from the user initiating the survey. The respondent could ask for a specific reward or signal an interest in general for a higher reward. If the user initiating the survey agrees, he or she will increase the reward however he or she chooses. The respondent who asked for the higher reward will be notified via message. In an embodiment, if the user who asked for a higher reward qualifies for a reward after responding to the survey, he or she will earn the higher reward. In another embodiment, any respondent who answers the survey and also qualifies to earn a reward will be presented the higher reward.

In one embodiment, after a respondent answers the survey, the user initiating the survey is given a time period to review the response and decide whether or not to verify it and allow a reward to be transferred to the respondent. If the user initiating the survey does not review the response within the given time period (for example, determined by the user initiating the survey or the survey server) the reward automatically is transferred to the respondent. If the user initiating the survey does verify the response and allow the reward to be transferred, the reward is also transferred to the respondent. If the user initiating the survey instead contests the response, he or she may prompt the respondent to fix the response by flagging certain elements in the response with indications for corrections by the respondent. If the respondent resubmits the survey with corrections, the process repeats itself. If after receiving a correction request, the respondent believes that he or she has already addressed problem, then he or she may submit a request to the survey server for moderator intervention. The moderator may be a designated user of the social network or someone outside of the social network to which the survey server sends an electronic communication to intervene in the dispute.

When the user initiating the survey defines rewards as coupons, the coupon can include a title, a description, a redemption period (for example, an expiration date), and an image. Each coupon has an identifier such as an alphanumeric code, a barcode, a QR code, another identifying code, or some combination. These coupon identifiers may be identical to each other or unique. A series of coupons may be generated when the user initiating the survey submits the survey. Unique coupons can be generated for however many respondents will receive the coupons.

When the respondent has qualified for a coupon, the coupon can be sent to the inbox of the respondent or the respondent may receive the coupon via email or other electronic communication. When the respondent receives the coupon, it could be opened or closed. Open coupons have identifiers that are visible to the respondent. The identifiers of closed coupons are not visible to the respondent. If the coupon is closed, the respondent can send a request to the survey server to open the coupon, after which the respondent would then be presented with a corresponding opened coupon.

In some embodiments, the coupon codes can be predetermined before any respondent has earned a coupon, and the coupon codes can be sent to the user initiating the survey when created. In other embodiments, the coupon codes can be determined or generated on an as-earned basis and sent to the user initiating the survey when earned. For both predetermined and generated as-earned coupon codes, the user initiating the survey will be able to redeem the coupons for or towards one or more goods and/or services to be provided to each survey respondent who has earned a reward from the survey and presented the coupon to the user initiating the survey, either in person, through the social network, or through some other physical or electronic communication.

The coupons can have validity dates during which they can be used, that is, they have a start date and an expiration date. The start date is when the earned coupon can begin being redeemed, and the expiration date is the date after which the coupon can no longer be redeemed. The surveys also have start dates and end or expiration dates. The start date is when the survey becomes active and potential respondents can begin responding to it; the expiration date is when the survey expires and potential respondents can no longer respond to it. In various embodiments, all the dates can be distinct or the dates may be interdependent. For example, the survey and coupon start dates could be the same and the survey and coupon expiration dates could be the same.

A respondent who have received a coupon may be allowed to trade the coupon on an exchange on the social network. The coupon may be traded for another coupon or coupons held by other users. Additionally, one combination of coupons could be exchanged for another combination of coupons. Coupons to be exchanged have to be unredeemed. Alternatively, cash, points, coupons, or a combination thereof may be exchanged for cash, points, other coupons, or a combination thereof.

The survey system could allow exchanges for any coupon that has not yet been redeemed. In this case, new coupon codes would be generated for each coupon, and the new codes would be transferred to both users who exchanged coupons, as well as these codes would be updated for the user initiating the survey who issued each coupon. Alternatively, the survey system could allow exchanges only of closed coupons. In this case, since all coupons are closed prior to the exchange, no new codes have to be generated.

Survey respondents may be allowed to delete their coupons, either closed or opened, from the network. Deleting coupons will result in a removal of the deleted coupon from the server.

For some coupons, the user initiating the survey may be able to confirm the coupon's redemption. Other coupons use self-confirmation. The user initiating the survey may have the ability to confirm that a given coupon has been redeemed, and thus designate the coupon as no longer redeemable. This may be done, for example, by entering the redemption code, clicking a button on the website, or through a scanner connected to the network that reads a coupon identifier. Respondents may also be able to independently self-confirm that they have redeemed coupons. If the user initiating the survey confirms the coupon's redemption, a signal will be sent to the survey server and then to the respondent who possessed the coupon. If the respondent confirms, a signal will be sent to the survey server and then to the user initiating the survey who issued the coupon.

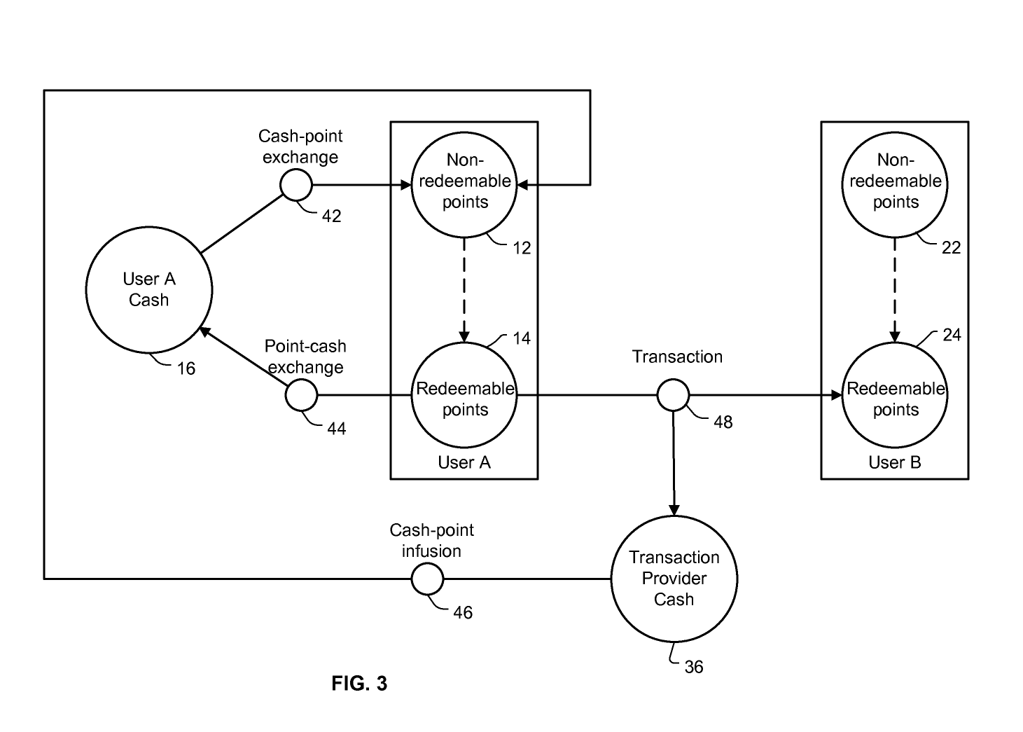

FIG. 3 is a flow diagram of aspects of an ecommerce system. The system implements an ecommerce system providing both redeemable points (redeemable for cash) and non-redeemable points. Alternatively, the ecommerce system can be implemented independently of the system for conducting surveys in a social network environment. The ecommerce system also includes one or more exchange rates between redeemable points and cash, and provides for transaction and infusion events impacting the transaction provider and the users of the ecommerce system. The transaction provider may also be the provider of the survey server. The ecommerce system may be implemented by the reward module 260 of the survey server of FIG. 2 to provide rewards to survey respondents.

Offering redeemable and non-redeemable points can provide significant advantages in the ecommerce system. Were there not these two classes of points, cash-point exchanges, point-cash exchanges, and cash-point infusions would become meaningless. In addition, segmenting points into two classes allows the system to associate cash and point flows more directly with the transaction provider's costs. In an embodiment, the non-redeemable points can be converted to redeemable points through a transaction. For example, if a first user awards non-redeemable points associated with that user to a second user, the system can convert the non-redeemable points to redeemable points. The second user can then choose to redeem the points for cash at an exchange rate or the second user can use the points in a subsequent transaction.

In one embodiment, the exchange rate between cash and points is constant and reflexive. That is to say, one point can be redeemed for X amount of currency when converting points to cash, one point can be purchased for X amount of currency when converting cash to points, and X is a fixed value. In one embodiment, there are three restrictions on exchanges to reduce exchange complexities. First, cash can only be converted to non-redeemable points. Second, only redeemable points can be converted to cash. Third, minimum deposit and minimum withdrawal values are set to prevent users from depositing and withdrawing too small cash denominations. These restrictions prevent users from repeatedly depositing and then withdrawing from the ecommerce system. Were they not in place, the transaction provider could potentially incur unwanted and cumbersome costs.

Both redeemable and non-redeemable points may be used in the system. In one embodiment all non-redeemable points are automatically used (applied to make a payment) before any redeemable points are used. Users may use points to purchase virtual goods and real goods and services from the transaction provider as well as from affiliated companies. Points may be used for transactions of goods and services between users (e.g., rewards that can be awarded to respondents of a survey). Whenever such a transaction between users occurs, the seller of the good or service associated with the transaction receives only redeemable points. Therefore, any non-redeemable points spent by the buyer of the good or service are automatically converted to redeemable points.

The flow diagram of FIG. 3 shows points and cash associated with two users, user A and user B, and the transaction provider. User A may exchange cash 16 for non-redeemable points 12 in a cash-point exchange 42. User A may also exchange redeemable points 14 for cash 16 in a point-cash exchange 44. In a transaction between user A and user B, user A's redeemable points 14 are transferred to user B's redeemable points 24 in a transaction 48. Some of these points may be converted to cash that is transferred to the transaction provider's cash 36. The transaction provider may convert cash 36 to non-redeemable points 12 in a cash-point infusion 46. Although the flow diagram of FIG. 3 shows particular entities involved in each transaction, it should be understood that the illustrated transactions are examples and many other transactions are also possible.

Four example transactions implemented through the ecommerce system further illustrate the system. In a first example, a user offers P points to another user for a good or service. The other user receives (P−r×P) points, where r is a transaction fee percentage. The transaction provider (owner of the points system) receives as revenue the equivalent of r×P points in cash.

In a second example, a user offers P points to another user who receives those P points. However, the original user must pay to the transaction provider an additional a×P points, where a is an augmented transaction fee percentage. The transaction provider receives as revenue the equivalent of a×P points in cash.

In a third example, a user offers P points to another user who receives those P points. However, the original user must pay an additional n points to the transaction provider, where n is a nominal transaction fee. The transaction provider receives as revenue the equivalent of n points in cash.

In a fourth example, a combination of any of the three previous examples is used. The values of r, a, and n can be varied depending, for example, on the cost of the transactions, the types of transactions, the user or users associated with the transactions, or a combination thereof. The revenues gained by the transaction provider can be used to cover the operational costs of the transactions and related services as well as for profit.

In addition, the transaction provider can take part in a cash-for-points (cash-point) infusion, in which the transaction provider's cash is converted to non-redeemable points for a given user of the ecommerce system. Possible sources of the cash include ecommerce transaction fees and website advertising revenues. A cash-point infusion may be associated with actions of the given user on the website, and in this sense infused points are a reward from the transaction provider to that user.

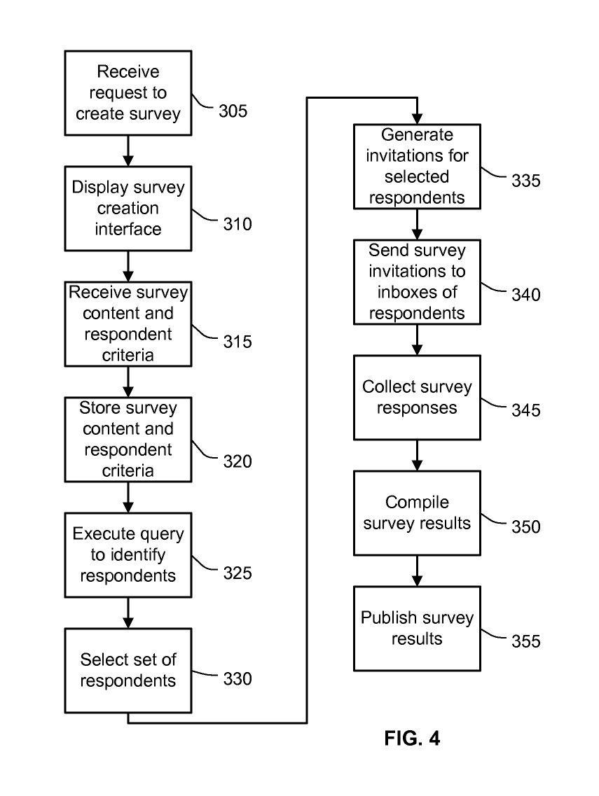

FIG. 4 is a flowchart of a process for creating a survey and processing survey results. The process can be implemented by the survey server 120 illustrated in FIGS. 1 and 2. Various steps of the process can be performed by the survey module 250 or the query module 240 of the survey server of FIG. 2. The process can be used to invite respondents to participate in a private survey in which only invited respondents from the social network can participate in the survey.

In block 305, the process receives a request to create a new survey. The request may come from a user of a social network service, such as that provided by the social network server 130. In an embodiment, the request is initiated by clicking a hyperlink or activating a button or other user interface navigational component that sends a request to the process.

In block 310, the process displays a survey creation interface to the user initiating the survey. The survey creation interface can be displayed in response to the request received in block 305. The process may use the user interface module 235 of the survey server of FIG. 2 to provide a web page or other interface to the user that allows the user to provide survey content and to enter survey properties.

In block 315, the process receives survey content and respondent selection criteria. The survey content can be provided by the user initiating the survey via the survey creation interface displayed in block 310. The respondent selection criteria can be provided similarly.

The user initiating the survey can delete the survey, either in draft form or active or completed form, from the network. If the survey is active when deleted, it will no longer be active, and respondents who could respond to it no longer can respond. If it is active or completed when deleted, the responses to the survey may be removed from the survey server. The user initiating the survey may have the ability to copy drafts, active surveys, or closed surveys and create new drafts identical to these copies.

In addition to uploading media to create a survey, the user initiating the survey may also be able to embed media through hyperlinks (or use just the hyperlink as part of survey prompts) to sites outside the social network.

The user initiating the survey can elect to set a date in the future during which a survey will become active. This is similar to submitting the survey, but in advance. If the user initiating the survey elects to use this functionality, then the survey will become active at whatever date was set, independently of whether the user initiating the survey returns to the draft survey at any other time before the set active date.

The server can limit the total number of surveys in circulation. The limit may be on the user initiating the survey end (for example, there can only be twenty surveys issued by users from a given city at any time) or it may be on the respondent end (for example, one user can only respond to five surveys in one day). If the limit is on the user initiating the survey, a request to activate a survey by the user initiating the survey would be rejected if the maximum number is already in circulation. If the limit is on the respondent end, a user may only be able to see and respond to a given number of surveys in a given period. Alternatively, a request to respond to a given survey may be rejected if that user has exceeded his or her number of responses in a given period. Variations and combinations of the limits may also be used.

Users on the social network may have the ability to subscribe to a certain user initiating the survey. With this subscription, every time the particular user initiating the survey to which the user is subscribed issues a survey for which that user qualifies, the user will be notified via a message.

Users may have the ability to set filtering preferences on the visibility of surveys available to them. The visibility can be based on survey data or data about the user initiating the survey or based on the geolocation of the user initiating the survey or respondent. For example, a respondent may only wish to see surveys from retailers.

In block 320, the process stores the survey content and the respondent selection criteria received in block 315. For example, the content may be stored in the survey data store 290 and the respondent selection criteria may be stored in the query data store 285.

In block 325, the process identifies potential survey respondents. The process may query a database of user information to identify users that satisfy the respondent selection criteria received in block 320. For example, the process may query the user data store 280 to select a set of potential respondents to the survey based on the respondent selection criteria stored in query data store 285. The user data store 280 can store profile information for users of the social network service. The query module 240 can construct and execute a query based on the respondent selection criteria provided to select a set of potential respondents to the survey based on the selection criteria. In some embodiments, the user data store 280 includes user information that is shared by the social network service for the purposes of conducting surveys. This information can include user profile information.

In other embodiments, the query module 240 can construct a query based on the respondent selection criteria and execute the query by sending the query to the social network server 130. The social network server 130 can then execute the query on its user profile information. This allows the social network server 130 to retain control over its user profile information and avoids problems of maintaining and updating user data at the user data store 280. In some embodiments, the social network server 130 can provide an interface that allows for third party applications, such as the survey services disclosed herein, to query user profile information.

In block 330, after a pool of potential respondents that match the respondent selection criteria has been identified, query module 240 selects a set of respondents to be invited to respond to the survey. In an embodiment, all of the potential respondents who match the respondent selection criteria are selected to participate in the survey. In other embodiments, the user initiating the survey selects a number of potential respondents who match the respondent selection criteria to be invited to participate in the survey. When the pool of potential respondents identified by the query module 240 is greater than the number of respondents specified by the user, the query module 240 can use various techniques for selecting a set of respondents to be invited to participate from the pool of potential respondents. When the pool is smaller than the number of respondents specified by the user, the query module 240 can communicate with user interface module 235 to let the user know. In an embodiment, the pool of potential respondents includes all users who match the respondent selection criteria, while in other embodiments, the pool of potential respondents is limited to just those potential respondents who are currently online at the social network.

In block 335, the process generates invitations to participate in the survey for each of the selected respondents. In an embodiment, each of the users of the social network can have a private message inbox dedicated to receiving survey invitations from other users of the social network. The private message inbox dedicated to receiving server invitations may be identical to or distinct from another private message inbox that stores private correspondences between each user and other users of the social network. In block 340, the process sends the generated invitations to the users in the selected set of respondents. The message transmitted to the user may include a hyperlink that can be clicked on or otherwise activated by the respondent to direct the respondent's browser to a web page hosted by the survey server 120 that displays the survey content. The user may be provided a password or access code that the user can use to access the survey content by entering the password or access code on a web page hosted by the survey server 120. The message sent to the user's inbox can include a Universal Resource Locator (URL) to the web page hosted by the survey server 120. In some embodiments, a unique password or access code is provided to each user, which allows the survey server 120 to determine which of the selected respondents have participated in the survey.

In an embodiment, if the user initiating the survey indicates that the user wishes to remain private, the message can be sent anonymously to the selected respondents. The message can indicate that the user has been invited to participate in a survey by another user of the social network service and that the user initiating the survey wishes to remain anonymous. In an embodiment, users of the social network service can configure their privacy profile settings to preclude anonymous messages from being sent to them, and the query module 240 can select a pool of potential respondents whose privacy profile settings allow for anonymous messages to be received from other users of the social network. In some embodiments, the privacy profile settings can allow users to opt into receiving anonymous survey invitations while prohibiting the delivery of other types of anonymous messages.

In an embodiment, if the selected respondents have configured their personal profiles to indicate that they wish to participate in surveys but wish to remain anonymous, the user who initiated the survey is not provided with the identities of the selected respondents. The user initiating the survey can indicate in the query criteria that the query module 240 can include users in the pool of potential respondents that wish to remain anonymous. In some embodiments, the query module 240 can generate a unique identifier that is associated with the user profiles of the anonymous users that allows the response module 245 to keep track of which of the invited respondents have responded to the survey even though the identities of the respondents are kept secret from the user who initiated the survey.

In block 345, the process collects responses to the survey from the invited respondents. The process can store the responses received in the survey data store 290 and may provide updates to the user who initiated the survey regarding how many of the invited respondents have responded to the survey. If the user who initiated the survey set up an expiration date or time for the survey or set up a threshold number of responses for closing the survey, the process closes the survey to additional responses if the conditions for closing the survey are satisfied. The process may notify the survey module 250 that the survey has been closed. In an embodiment, if an invited respondent tries to participate in a survey after the survey has been closed, a message is displayed to the user that the survey has closed. An optional message from the user initiating the survey can also be displayed to the invited respondent thanking the invited respondent for their interest in the survey. In some embodiments, this message can include links to other surveys being conducted by the user who initiated the survey, to other content associated with the user who initiated the survey, or to other content associated with attributes of the survey. The process may also supply a reward to the respondent.

In block 350, after the results of the survey have been collected, the process compiles the responses received into survey results. The survey results can be published in various formats including a graphical representation of the results (e.g., a bar graph, a pie chart, or a histogram), a textual representation (e.g., a list or a table), or a combination thereof. Other organizational and analytical techniques may also be applied to the survey results. The survey results can be stored in multiple formats. For example, the survey results can be stored both as web page content and as downloadable content (e.g., PDF, SPSS, CSV, or XML files). The compiled results may be stored in the survey data store 290.

In block 355, the process publishes the compiled results of the survey. Publication depends in part on the level of visibility for the survey results selected by the user initiating the survey. If the user selected a level of visibility in which the survey results are not shared with respondents or other members of the social network service, the results of the survey can be compiled into a report that is transmitted to the user initiating the report. In some embodiments, the survey module 250 generates a report document and stores the report document in the survey data store 290. The user can then log into the survey server 120 to view or download the report document. In some embodiments, the process restricts visibility of the survey results. For example, the survey results may be published to a web page accessible to the respondents that were invited to participate in the survey, actual respondents to the survey, or some other subset of users. In other embodiments, the survey module 250 publishes the results of the survey to a publicly available location on the social network where users of the social network, and in some instances non-members of the social network, can view the survey results.

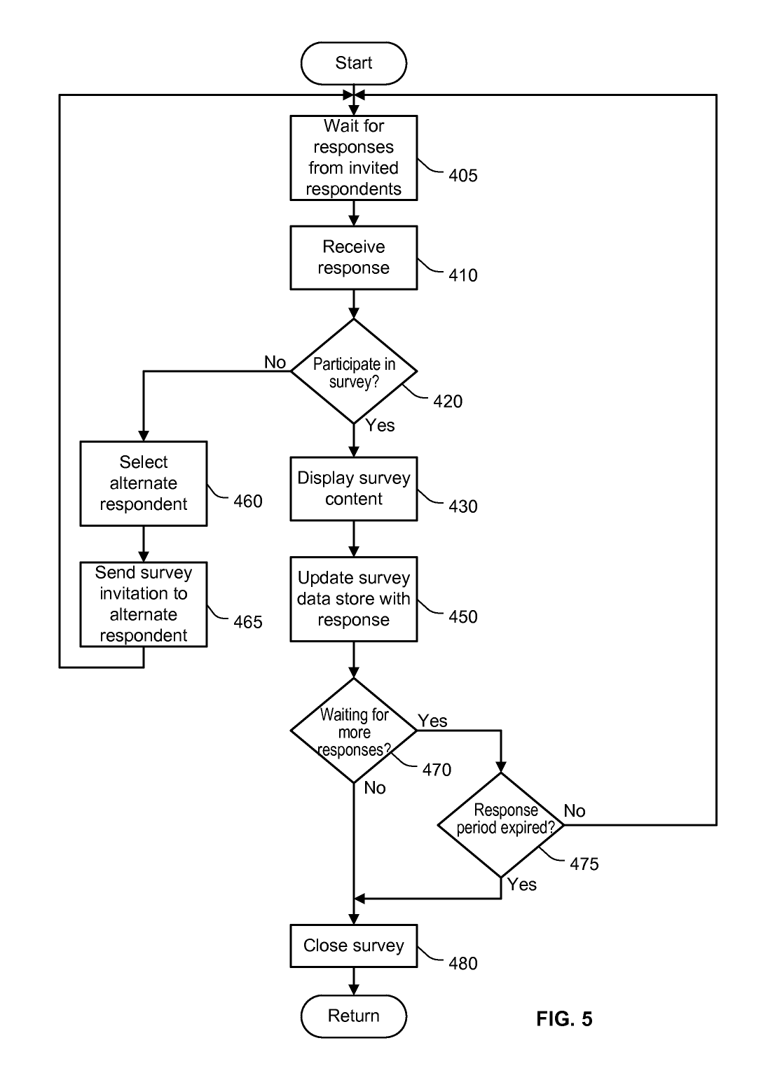

FIG. 5 is a flowchart of a process for collecting survey responses. The process may be used to implement block 345 of the process for creating a survey and processing survey results illustrated in FIG. 4. Various steps of the process illustrated in FIG. 5 can be performed by the response module 245 of the survey server.

In block 405, the process waits to receive responses from potential respondents that have been invited to participate in a survey. As described with respect to steps 335 and 340, invitations can be generated for a set of potential respondents from the pool of respondents identified by the query module 240 that match the respondent selection criteria provided by the user initiating the survey.

In block 410, the process receives a response to an invitation to participate in the survey at the survey server 120.

In block 420, the process determines whether the respondent has agreed to participate in the survey or declined to participate. The response module 245 can update the survey data store 290 with the response received. In an embodiment, the invitation to participate in the survey that was placed in the private inbox on the social network service for each of the invited respondents can include a hyperlink or other navigation tool that, if activated, indicates that the user agrees participate in the survey. The invitation can also include a hyperlink that, if activated, declines the invitation to participate in the survey. The process may also update the survey database with the response received. If the process determines that the user has agreed to participate, the process continues to block 430; otherwise, the process continues to block 460.

In block 460, the process selects an alternate respondent. The alternate respondent may be selected from the pool of respondents identified by the query module 240 in block 325 of the process illustrated in FIG. 4. Additionally, the selection may be preformed as described for block 330 of the process illustrated in FIG. 4.

In block 465, the process sends an invitation to participate in the survey to the private inbox of the alternate respondent. Information identifying the pool of potential respondents for the survey may be stored in the query data store 285. If there are no remaining respondents from the pool of potential respondents that have not yet been invited to participate in the survey, block 460 and 465 can be skipped and the process can instead continue to block 470.

In block 430, the process causes the survey content to be presented to the respondent in a survey interface, such as a web page. In some embodiments, contents of the survey are displayed to the user depending on the configuration and settings of the survey as determined by the user initiating the survey. For example, in some embodiments, the survey content may be displayed as part of the invitation to respond to the survey. In some embodiments, the survey content might be visible on a survey web page, in a message posted to a thread in a forum, and/or in another visible location within the content provided by the social network service that is accessible to members of the service. The process may determine whether the survey has been closed when the response is received. The survey interface can collect the information entered by the user in response to the survey and provide the information to the response module 245.

In block 450, the process stores the survey response information. The information may be stored in a database, for example, the survey data store 290. If the survey has been closed, the user can be presented with a screen indicating the survey has been closed to further responses instead of the survey content, and no survey response information is collected for that respondent. In some embodiments, it is possible that a survey could be closed due to an expiration of the response period or due to a threshold number of responses being received for the survey before a particular invited respondent attempts to respond.

In some embodiments, the invitations sent to the selected respondents have an expiration date or time associated with the invitations. If a selected respondent does not respond (as described for block 410) to the survey invitation before the expiration date or time, the process can automatically select an alternate respondent and send an invitation to participate in the survey.

In block 470, the process determines whether it is waiting for more responses from potential respondents that have been invited to participate in the survey. That the process is waiting for more responses may be determined when there are outstanding invitations for which the invited respondents have not either agreed to participate in the survey or declined to participate. When the process is waiting for more responses, the process continues to block 475; otherwise, the process continues to block 480.

In block 475, the process determines whether the response period to respond to the survey has expired. If the response period has expired, the process continues to block 480; otherwise, the process returns to block 405. The process may, in some embodiments, transition to block 475 at certain time intervals. These transitions can occur, for example, from block 405.

In block 480, the process closes the survey to additional responses. The process can then notify, for example, the process for creating a survey and processing survey results illustrated in FIG. 4, which can compile the survey results.

The process for collecting survey responses, in various embodiments, may add, omit, reorder, or alter the illustrated blocks. For example, in embodiments where all potential respondents matching the query are invited to participate in the survey, blocks 460 and 465 may be omitted with the process continuing from block 420 to block 470.

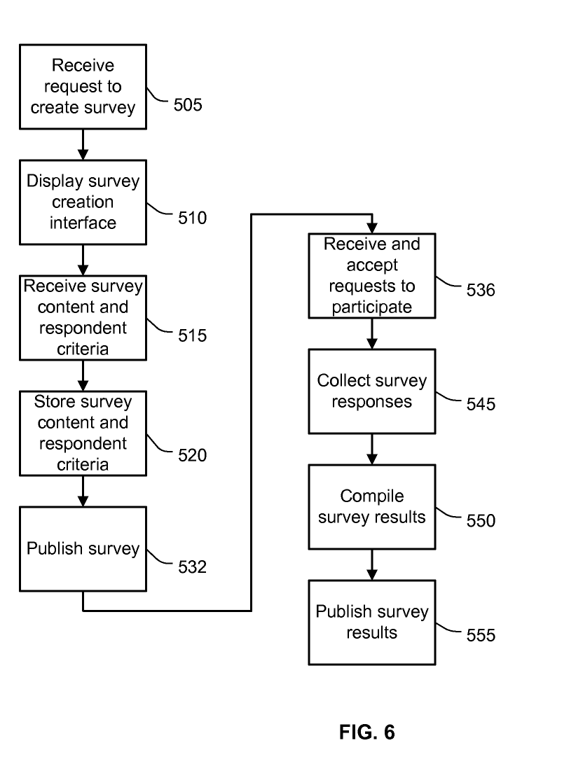

FIG. 6 is a flowchart of another process for creating a survey and processing survey results. The process can be implemented by the survey server 120 illustrated in FIGS. 1 and 2. Various steps of the process can be performed by the survey module 250 of the survey server. The process illustrated in FIG. 6 can be used to create a public survey where any users from the social network meeting the respondent criteria can participate in the survey, rather than only invited participants as described in the process illustrated in FIG. 4.

In block 505, the process receives a request to create a new survey. In various embodiments, block 505 is the same or similar to block 305 of the process of FIG. 4.

In block 510, the process displays a survey creation interface to the user. In various embodiments, block 510 is the same or similar to block 310 of the process of FIG. 4.

In block 515, the process receives survey content and respondent selection criteria from the user. In various embodiments, block 515 is the same or similar to block 315 of the process of FIG. 4. The respondent selection criteria, however, is used to determine eligibility of users requesting to respond to the survey rather than used to determine which users to invite to participate.

In block 520, the process stores the survey content that has been received from the user in the survey data store 290 and the respondent selection criteria provided by the user in the query data store 285. In various embodiments, block 520 is the same or similar to block 320 of the process of FIG. 4.

In block 532, the process announces the survey. The process may announce the survey by posting the survey content to a location that is publicly available on the social network. The publicly available location may be a webpage or other content location that is accessible by any user of the social network services. The process may also announce the survey by an advertisement for the survey displayed to users of the social network. For example, the announcement can be displayed as an embedded advertisement on a web page of the social network service. The survey announcements may also be displayed on pages associated with the users' profiles. The survey announcement can also be placed on web pages that offer various interactive content, such as games, chat tools, or surveys, to the users of the social network service. The survey announcement may include a hyperlink or other navigational element that, if activated, causes the browser of the user activating the navigational element to display the survey content. The survey content itself may alternatively be embedded in a web page that is part of the social network service. In some embodiments, the survey may only be visible publicly to users who meet the respondent selection criteria for the survey.

In block 536, the process receives requests to participate in the survey from users of the social network. For example, a user of the social network can activate a hyperlink or other navigational element included in the survey announcement to send a request to the survey server 120 that the user be able to participate in the survey. In block 536, the process also determines whether the requested came from user who is eligible to participate in the survey based on the respondent selection criteria received in block 515. In block 536, the process also determines whether a target number of invitations to participate has already been distributed to potential respondents. In some embodiments, a pool that includes a limited number of invitations to participate in the survey can be placed in a public area on the social network service. If a user of the social network service requests to participate in the survey, an invitation to participate in the survey can be placed in the private inbox of the requesting user and the pool of available invitations is reduced by one. In some embodiments, the user can elect to take the survey directly, without the message being placed in that user's private inbox. In those embodiments, the process presents the survey contents to user and collects the results.

In block 545, the process collects responses to the survey from respondents who chose to participate in the survey. The process may store the responses received in a database and provide updates to the user initiating the survey regarding how many responses have been received. If the user who initiated the survey set up a completion date or time for a survey or set up a threshold number of responses for closing the survey, the process can close the survey to additional responses if the conditions for closing the survey are satisfied. In an embodiment, if an invited respondent tries to participate in a survey after the survey has been closed, a message can be displayed to the user that the survey has closed. An optional message from the user initiating the survey can also be displayed to the invited respondent thanking the invited respondent for his or her interest in the survey. In some embodiments, this message can include links to other surveys being conducted by the user who initiated the survey, to other content associated with that user, or to other content associated with the properties of the survey. The process may also supply a reward to the respondent.

In block 550, the process compiles the responses received into survey results. In various embodiments, block 550 is the same or similar to block 350 of the process of FIG. 4.

In block 555, the process publishes the compiled results of the survey. In various embodiments, block 555 is the same or similar to block 355 of the process of FIG. 4.

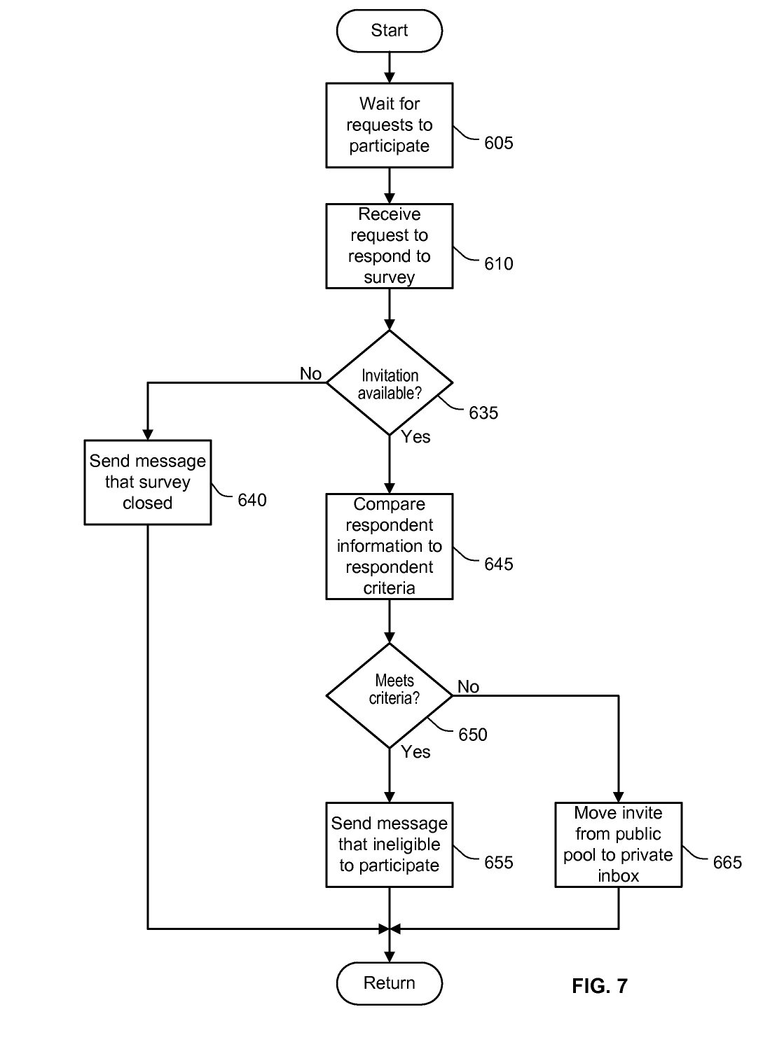

FIG. 7 is a flowchart of a process for processing survey participation requests. The process can be used to implement step 536 of the process for creating a survey and processing survey results illustrated in FIG. 6. The process illustrated in FIG. 7 can be implemented by the response module 245 of the survey server.

In block 605, the process waits to receive requests to participate in the survey from potential respondents.

In block 610, the process receives a request to participate in the survey. As described with respect to steps 532 and 536, a user of the social network can activate a hyperlink or other navigational element included in the survey announcement to send a request to participate in the survey.

In block 635, the process determines whether there are any invitations remaining in a pool of invitations. The process keeps track of a pool of invitations that can be assigned to respondents who indicate that they would like to participate in the survey. In an embodiment, a starting size of the pool of invitations can be based on a number of survey responses that the user initiating the survey desires to receive. In an embodiment, the survey creation interface can collect the size of the pool of invitations to be created from the user initiating the survey.

If no invitations remain in the pool of invitations, the process continues to block 640 and sends a message to the user requesting to participate in the survey that the survey is currently closed.

If an invitation is available in the pool of invitations, the process continues to block 645 and compares profile information for the potential respondent to respondent selection criteria entered by the user initiating the survey to see if the potential respondent qualifies to participate in the survey.

In block 650, the process determines whether the potential respondent is eligible to participate in the survey based on the comparison performed in block 645. If the potential respondent is not eligible, the process continues to block 655; otherwise, the process continues to block 665.

In block 655, the process sends the potential respondent a message indicating that he or she is not eligible to participate. For some surveys, the user initiating the survey may indicate that there are no respondent selection criteria (or may provide none), and any user of the social network service can respond to the survey as long as there are invitations remaining in the pool of invitations.

In block 665, the process sends an invitation to participate in the survey to the private inbox of the potential respondent. The potential respondent can then access the invitation in his or her private inbox on the social network in order to participate in the survey. In another embodiment, the potential respondent can participate in the survey immediately by clicking on a hyperlink or other navigational tool. The process also decreases the pool of available invitations by one.

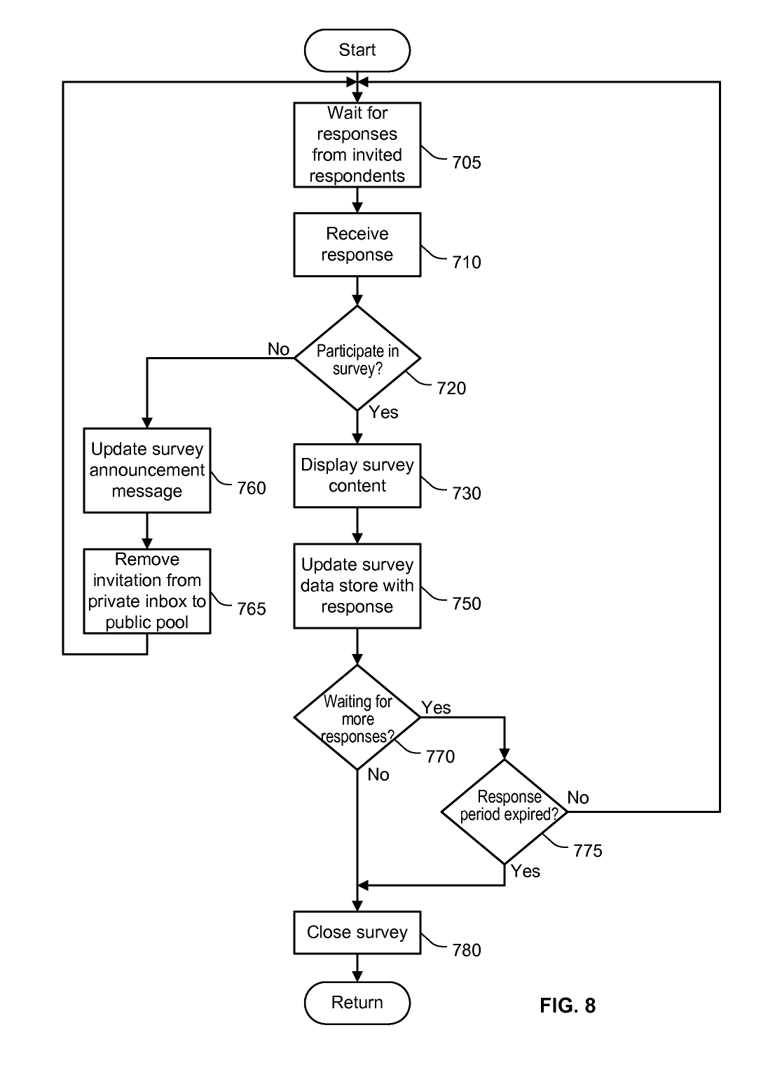

FIG. 8 is a flowchart of a process for collecting survey responses. The process can be used to implement step 545 of the process for creating a survey and processing survey results illustrated in FIG. 6. Various steps of the process illustrated in FIG. 8 can be performed by the response module 245 of the survey server.

In block 705, the process waits to receive responses from potential respondents that have been invited to participate in the survey. In various embodiments, block 705 is the same or similar to block 405 of the process of FIG. 5. The potential respondents may have received an invitation in response to requesting to participate in the survey.

In block 710, the process receives a response to an invitation to participate in the survey. In various embodiments, block 710 is the same or similar to block 410 of the process of FIG. 5.

In block 720, the process determines whether the respondent has agreed to participate in the survey or declined to participate. The invitation to participate in the survey can include an option that allows the user to decline to participate in the survey even when the invitation was sent in response to the user requesting to participate in the survey. In various embodiments, block 720 is the same or similar to block 420 of the process of FIG. 5. If the process determines that the user has agreed to participate, the process continues to block 730; otherwise, the process continues to block 760.

In block 760, the invitation corresponding to the response received in block 710 is returned to the pool of invitations. When an invited respondent does not respond to the survey invitation before an expiration time, the invitation can also be removed from the private inbox of the invited respondent and returned to the pool of invitations.

In block 765 the process updates the survey announcement. For example, the survey announcement might include a counter of then number of invitations remaining to create a sense of urgency on the part of users who may be interested in responding.

In block 730, the process causes the survey content to be presented to the respondent in a survey interface. In various embodiments, block 730 is the same or similar to block 430 of the process of FIG. 5. The operations of block 730 or a similar block may also be performed when a potential survey respondent can participate in a survey immediately by clicking on a hyperlink or other navigational tool.

In block 750, the process stores the survey response information. In various embodiments, block 750 is the same or similar to block 450 of the process of FIG. 5.

In block 770, the process determines whether it is waiting for more responses. In various embodiments, block 770 is the same or similar to block 470 of the process of FIG. 5. The responses are to invitations supplied to those who requested to participate in the survey. The process may also determine whether a minimum number of responses requested by the user initiating the survey has been received. If there are no outstanding invitations for which the invited respondents have not either agreed to participate in the survey or declined to participate, or the minimum number of responses has been satisfied, the process continues to block 780; otherwise, the process continues to block 775.

In block 775, the process determines whether the response period to respond to the survey has expired. If the response period has expired, the process continues to block 780; otherwise, the process returns to block 705. The process may, in some embodiments, transition to block 775 at certain time intervals. These transitions can occur, for example, from block 705.

In block 780, the process closes the survey to additional responses. In various embodiments, block 780 is the same or similar to block 480 of the process of FIG. 5. The process may also close the survey when it determines that the response period to respond to the survey has expired.

Those of skill will appreciate that the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A computer-implemented method for conducting a multimedia survey of users of a social network, the method comprising:
receiving survey attributes from a first one of the users;
identifying users eligible for the survey based on the survey attributes;
selecting potential respondents from the users identified as eligible;
inviting the selected potential respondents to respond to the survey; and
collecting responses from the invited potential respondents.

2. The method of claim 1, further comprising receiving a request to create the survey from the first user.

3. The method of claim 1, wherein the survey attributes comprise respondent selection criteria.

4. The method of claim 3, wherein selecting potential respondents comprises querying a database of user information for users that satisfy the respondent selection criteria.

5. The method of claim 1, wherein the survey attributes comprise survey content selected from the group consisting of an image, audio, video, and a game.

6. The method of claim 1, wherein the survey attributes comprise user data requests for attributes of the respondents.

7. The method of claim 1, wherein inviting the selected potential respondents comprises:
generating invitations to participate in the survey for the selected potential respondents; and
sending the invitations to the selected potential respondents.

8. The method of claim 7, wherein sending the invitations comprises sending the invitations to private inboxes in the social network associated with the selected potential respondents.

9. The method of claim 1, wherein collecting responses comprises:
receiving a response from one of the invited potential respondents;
determining whether the response indicates that the one of the invited potential respondents agrees to participate in the survey.

10. The method of claim 9, wherein collecting responses further comprises:
when the response indicates that the one of the invited potential respondents does not agree to participate in the survey,
selecting an alternate potential respondent from the users identified as eligible and
inviting the selected alternate potential respondent to respond to the survey.

11. The method of claim 9, wherein collecting responses further comprises:
when the response indicates that the one of the invited potential respondents agrees to participate in the survey,
displaying contents of the survey to the one of the invited potential respondents and
receiving a response to the survey from the one of the invited potential respondents.

12. The method of claim 1, further comprising compiling survey results based on the collected responses.

13. The method of claim 12, wherein the compiled survey results are only disclosed to the first one of the users.

14. The method of claim 12, further comprising publishing the compiled survey results on the social network.

15. The method of claim 14, wherein the published survey results are not disclosed to users from whom a survey response was not collected.

16. The method of claim 1, further comprising transferring a reward from the first user to at least some of the invited potential respondents from whom responses are collected.

17. The method of claim 16, wherein the reward is selected from the group consisting of cash, points, and a coupon.

18. A computer-implemented method for conducting a multimedia survey of users of a social network, the method comprising:
receiving survey content and respondent eligibility criteria from a first one of the users;
announcing the survey to at least some of the users;
receiving requests to participate in the survey from some of the users;
allocating invitations to participate in the survey to a selected set of the users from which requests to participate in the survey were received; and
collecting survey responses from the selected set of the users.

19. The method of claim 18, further comprising:
compiling a set of survey results based on the survey responses collected from the selected set of the users; and
publishing the compiled survey results on the social network.

20. The method of claim 19, wherein the published survey results are not disclosed to users from whom a survey response was not collected.

21. The method of claim 18, wherein allocating invitations comprises:
determining whether the users from which requests to participate in the survey were received satisfy the respondent eligibility criteria; and
inviting the users who satisfy the respondent eligibility criteria to respond to the survey.

22. The method of claim 21, wherein the survey content is not disclosed to users who do not satisfy the respondent eligibility criteria.

23. The method of claim 18, wherein the survey is announced only to the users who satisfy the respondent eligibility criteria.

24. The method of claim 18, further comprising transferring a reward from the first user to at least some of the invited potential respondents from whom responses are collected.

25. The method of claim 24, wherein the reward is selected from the group consisting of cash, points, and a coupon.
